(19) United States
(12) Patent Application Publication
(10) Pub. No.: US 2005/0035607 A1
(43) Pub. Date: Feb. 17, 2005

(54) Highway nose

(76) Inventor: Joseph Morgese, Daytona Beach, FL (US)

Correspondence Address: Joseph Morgese;Suite 606, PMB 389, 1500 Beville Road, Daytona Beach, FL, 32114, US

(21) Appl. No.: 10/919,045

(22) Filed: Aug. 14, 2004

Related U.S. Application Data
(60) Provisional application No. 60/494,930, filed on Aug. 14, 2003.

(51) Int. Cl. B60R 19/16

(52) U.S. Cl. 293/49

(57) ABSTRACT

The Highway Nose is a protective assembly of various parts for converting head-on collisions into side-swipes consisting of a roller (4) at the front, and conveyors (3) just behind and on both sides, that are set on shock-absorbers (6) and the conveyors are hinged (2) onto a connector plate (5) which in turn is hinged (13) to a see-saw fulcrum (12) and equipped with shock absorbers (11) as well allowing the entire assembly to flex a bit to one side or the other. A wheel (14) underneath the roller(4) stabilizes stationary assemblies, while allowing the flex movement

### CROSS-REFERENCE TO RELATED APPLICATIONS

This application claims the benefit of Provisional Patent Application Ser. No. 60/494,930, filed on Aug. 14, 2003.

### BACKGROUND

1. Field of the Invention

This invention caters to the safety needs of the transportation industry, specifically, as a way for tractor-trailers, and any other vehicle, to have a bumper that is designed to roll away any thing that it may come into contact with, thereby decreasing the potential damage and loss of life that comes from these collisions by converting the direct head-on energy of a head-on collision into a less dangerous side-swipe collision.

Another application applies to stationary objects that could use this invention such as toll booths and overpass columns, thereby minimizing damage to impacting vehicles.

Yet another application would work at the rear end of highway vehicles.

2. Prior Art

There currently exists on the market, your normal bumpers, which do absolutely nothing but absorb the energy from the crash of head-on collisions. They are made of heavy materials such as metal, and are designed to protect the vehicle, relatively speaking, in the event of a collision.

But, what if these bumpers would have a design built in with rollers and conveyors, that would deflect a collision, thereby minimizing the damage and injury potential?

Also, there does exist a special bumper currently found at the rear end of highway maintenance vehicles, designed to absorb high amounts of impact energy, thus showing that there is a need for this invention as yet another method for dealing with that issue.

Furthermore, at toll booths and overpass columns, where they are currently using barrels filled with water, as a way to soften the impact of a collision, this invention would work enhance safety by diverting the colliding vehicle away from the stationary object.

### OBJECTS AND ADVANTAGES

The Highway Nose system addresses those issues, by providing a simple, set of rollers and conveyors, that would serve to deflect the impact energy from a collision. While this discourse will concentrate on the front of the vehicle, the reader may take it to apply to the rear of a vehicle and stationary objects as well.
a special designed roller at the very front of the invention, that rolls either way, depending on the tendency of the collided object to go either to the driver side or to the passenger side,
conveyor belts on either side of the roller that continue to usher the collided object off to the side of the vehicle,
the roller and the conveyor belt mechanisms have stems that give way, like a shock absorber, to take some of the impact energy, while the remainder of that energy is rolled away off towards the side and the entire highway nose also has stems at the connector plate that further absorbs impact energy.
   List of Reference Numerals
1-front of vehicle, rear of vehicle, stationary object
2-hinge for conveyor belt mechanism
3-conveyor belt mechanism
4-roller at front and center
5-connecting plate at vehicle, in place of (standard bumper)
6-shock absorbing stems for the roller and the two conveyor belt mechanisms
7-conveyor belt
8-rollers for conveyor
9-framework for conveyor belt
10-spindle for main roller
11-shock-absorbing stems for highway nose assembly
12-see-saw part of the connector plate
13-hinge connecting connector plate to see-saw fulcrum
14-roller wheel for stationary object applications

### DRAWING FIGURES

FIG. 1 Isometric Drawing

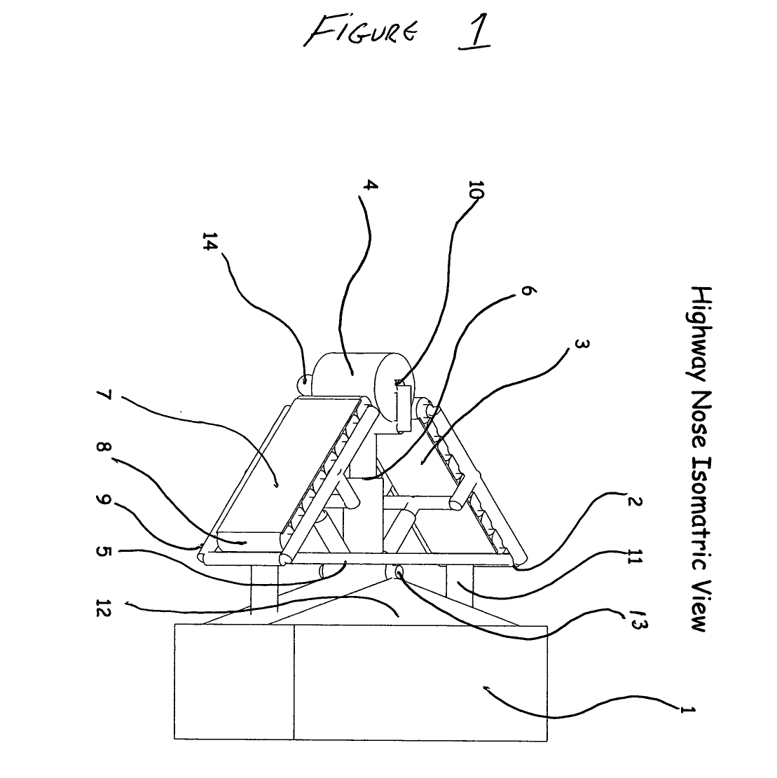

FIG. 2 Top View Drawing

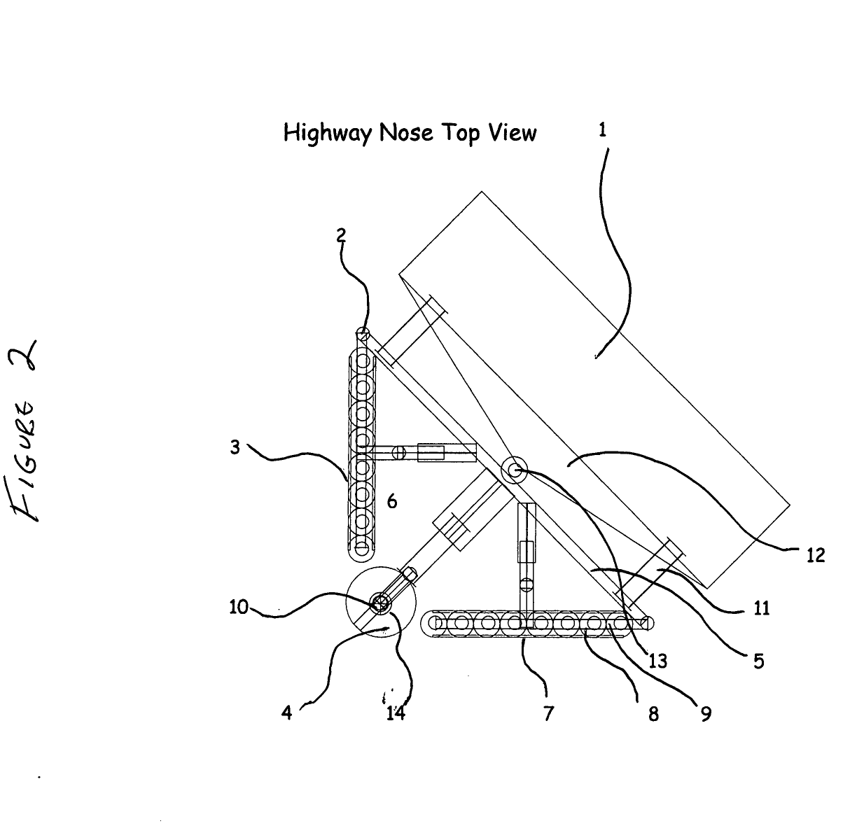

FIG. 3 Isometric Drawing rendered

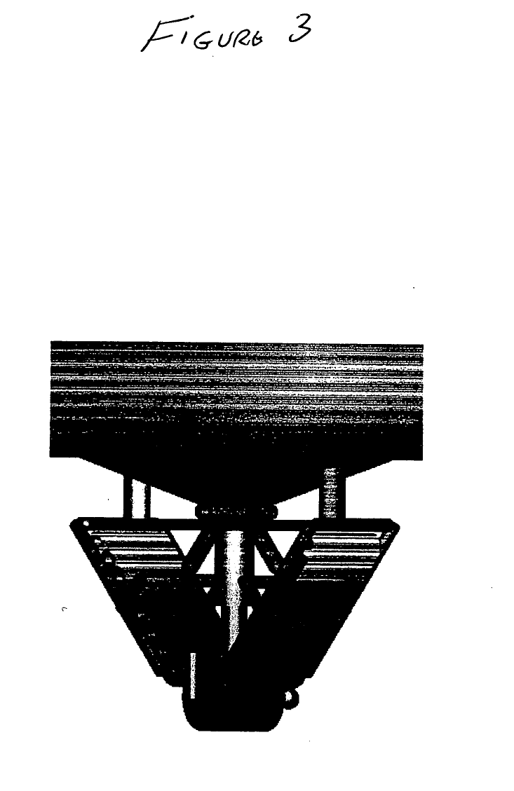

### SUMMARY OF THE INVENTION

The Highway Nose allows for diminished damages to the vehicles, injuries and casualties to the parties involved in the collision, by diverting and deflecting the energy of the impact.

It turns head-on collisions into sideswipes for all applications, whether it is used at the front of a vehicle, at the rear, or on stationary objects.

### DESCRIPTION

### Main Embodiment

Drawing Number 1 . . . Isometric View

The Highway Nose has a roller (#4) at the very front, that is made of rubber, or any suitable material for the task of absorbing and softening impact, among other materials, that will roll either towards the passenger side or towards the driver side, causing the object of impact, who's tendency is to keep going head-on, to be diverted to go towards either side of the vehicle, depending on the object's tendency.

The roller (#4) is set on a spindle (#10) which is connected to a shock-absorbing stem (#6), which helps to absorb the initial impact energy, while the roller diverts the remaining bulk of that energy off towards one side or the other.

On either side of this roller, are the conveyor belt mechanisms (#3), that will continue to roll away the object of impact along, away from the front of the vehicle, and off towards the side, away from the force of impact.

These conveyor belt mechanisms, on either side and behind the roller, are framed and connected to shock-absorbing stems as well. (#6)

The shock-absorbing stems are connected to the connecting plate (#5), which is placed where the bumper would normally be, at the front of the vehicle (#1).

Also, at the connecting plate (#5), the conveyor belt mechanism's hinges (#2) are situated at the outer ends of the connecting plate, that allow for the conveyor belt mechanism to flex inward against the shock-absorbing stems, as the conveyor belt absorbs some of the impact energy, while the bulk of the remaining impact energy is rolled along the belt and diverted sideways and away from the front of the vehicle.

The connector plate has a see-saw attachment (#12) connecting to it at the hinge (#13), and houses two more shock-absorbing stems (#11), all of which serve to absorb and further deflect the impact energy off toward the side.

For stationary applications, a wheel (#14) is used to support the highway nose and to allow it to roll to one side or the other depending on the direction of the impacting energy.

Operation-Main Embodiment

The roller (#4) si the first line of defense, set at the front of the vehicle (#1) and will work to absorb the main thrust of the impact. It is set on a vertical axis to roll either towards the passenger side or towards the driver side. It's spindle connects to the stem (#6). The bottom of the roller is flat but the top may be rounded for aero-dynamic purposes. The roller is made of lightweight yet strong material and may be solid all the way through. A material that will allow it to sustain the impact. Testing will determine the best material for this. As technology advances, better materials will make this invention even more viable in the future.

The stem (#6) is built like a shock absorber, to collapse a bit upon impact thereby absorbing some of the initial impact energy, while the roll of the roller takes the remainder of the impact energy and rolls and diverts this energy onto the conveyor belt (#3), situated on either side of the roller, to continue to divert the energy away from the front of the vehicle to the relative safety of the side of the vehicle, thus turning a head-on collision into a side-swipe. Hopefully, a much safer alternative.

The conveyor belt mechanisms (#3) are identical and are on either side of the roller and serve the same function as the roller, as a deflection device and placed in such a way as to enhance aero-dynamic principles. They, too, have rollers and conveyor belts that will allow any object it hits to roll off to the side, thus averting a head-on collision, and are hinged (#2) at the connecting plate (#5) giving it the flex to absorb some impact energy against the shock absorbing stems (#6).

The connector plate (#5) is hinged (#13) onto a see-saw fulcrum (#12) with two more shock-absorbing stems (#11), thus providing even more impact energy absorbency and deflection. When the highway nose is hit, it too moves a bit to one side or the other and this activates the see-saw (#12) and the stems (#11).

For stationary objects, the stabilizing wheel (#14) helps roll the highway nose.

### CONCLUSION, RAMIFICATIONS, AND SCOPE

Thus the reader will see that the Highway Nose provides a means of turning a head-on collision into a side-swipe, which is a much safer alternative. While we would all prefer no accident at all, the “jujitsu” maneuver of this invention uses the energy of the impact to move the vehicle off the front and towards the side of the vehicle.

For moving vehicles, the added weight and cost of such a contraption may or may not justify it's viability at this time, however, as new and better materials and processes develop, that may change.

It's a start of a technology which can only improve with time as scientists and engineers begin to develop better materials and processes in this direction.

It can also be installed at the rear of a vehicle, as for vehicles that constantly stop and go such as highway maintenance vehicles and highway patrol cars.

As well, as a stationary object's line of defense on the highway, where weight is not an issue, the highway nose will work to enhance safety on our highways.

1- A method for diverting the impact energy of a head-on collision, comprising the steps of:
a. upon impact, the main roller, situated at the very front, takes said impact, and is connected to a collapsible stem which absorbs some of the initial shock while the remainder of said impact energy rolls off of said roller either towards the driver side or towards the passenger side,
b. said impact energy continues along conveyors situated on either side and just behind said roller further diverting said impact energy away from the front and off to the side,
c. entire assembly offsets as well, to one side or the other and said impact energy is finally fully diverted,
Whereby said impact energy of a head-on collision is diminished and turned into a side-swipe situation. A much less severe scenario.

2- The method of claim #1, whereby said roller is set on a vertical spindle, and is connected to said shock-absorbing stem,

3- The method of claim #1, whereby said conveyors are set in a frame, connected to shock-absorbing stems, and hinged to a connector plate to allow some flexing,

4- The method of claim #1, whereby said connector plate is hinged as well, onto a see-saw fulcrum and also has shock absorbing stems, to allow even more flexing,

5- The method of claim #1, whereby, for stationary applications, such as toll booths and overpass columns, a wheel set underneath said roller, stabilizes the said highway nose assembly and allows said assembly to sway a bit, one way or the other, to further absorb and divert said impact energy,

6- The method of claim#1, whereby said assembly sways one way or the other on said wheel, and said connector plate, that is said hinged at said see-saw to allow said sway movement, and equipped as well with said shock-absorbing stems, all of which do the work of absorbing and diverting said impact energy off away from the front and to the side,

7- The method of claim #1, whereby suitable materials for said roller and conveyor belts may be made of materials coming from a group comprising of rubber, plastics, foam to help absorb the impact, yet must not disintegrate upon impact,

8- The method of claim #8, whereby suitable materials for said shock-absorbing stems may be coming from a group comprising of springs, hydraulic or air shock absorbers to absorb said impact energy,

9- The method of claim #1, whereby the actual angle of said highway nose assemble may be more acute, or less for differing applications, given that stationary could afford more conveyor space.

10- A device that is placed in a position for enhancing protection from head-on collisions, whether it be used like a bumper at the front or the rear of a vehicle, or used like a guard rail for stationary objects on the highway that need protection from oncoming vehicles, comprising:
a. said device heretofore called highway nose assembly, triangular in shape, with a vertical roller at the front for meeting impact, and
b. said roller's spindle is connected to a shock-absorbing stem which collapses a bit to absorb some of initial said impact, while said roller rolls off remaining said impact energy, and
c. conveyor belts located just behind and on both sides of said roller that are set with a frame and hinged at one end to a connector plate, and
d. said frame of said conveyor belts are connected to shock-absorbing stems, whereby along with said hinge, allow the conveyors to flex a bit and absorb some more of said impact energy as said conveyors continue to deflect said impact energy along sideways, and
e. said connector plate is hinged at a see-saw fulcrum and equipped with a plurality of shock-absorbers, thus allowing the entire said highway nose assembly to flex a bit either to one side or the other as said impact energy is diverted to said one side or the other, and
f. for stationery applications, a stabilizing wheel is used underneath said roller and accommodates said flex movement of said assembly.

11- The device of claim #10, whereby materials for said roller and conveyor belts may come from a group comprising rubber, plastic or foam and yet be strong as to not disintegrate upon said impact,

12- The device of claim #10, whereby suitable materials for said shock-absorbing stems may be coming from a group comprising of springs, hydraulic or air shock absorbers to absorb said impact energy,

13- The device of claim #10, whereby the actual angle of said highway nose assembly may be more acute, or less, for differing applications, given that said stationary assemblies could afford more of said conveyor space.

14- The device of claim #10, whereby the height of said assembly may differ, given that said stationary assemblies could afford taller versions of said assemblies.
